(19) United States
(12) Patent Application Publication
(10) Pub. No.: US 2002/0100357 A1
(43) Pub. Date: Aug. 1, 2002

(54) Asymmetrical dual plane guitar body for solid body guitars, an invention that enables the musician to enjoy the advantages of playing in a sitting position while standing

(76) Inventor: David Allen Williams, Roseburg, OR (US)

Correspondence Address: David A. Williams, 3840 Hooker Rd., Roseburg, OR, 97470, US

(21) Appl. No.: 10/024,900

(22) Filed: Dec. 18, 2001

Related U.S. Application Data
(60) Provisional application No. 60/257,782, filed on Dec. 26, 2000.

(51) Int. Cl. G10D 3/00

(52) U.S. Cl. 84/291

(57) ABSTRACT

A solid body electric guitar or bass guitar whereas the body of the guitar is divided into two separate planes so as to conform to the torso of the human body. The asymmetrical position of the “neck and string assembly” in relation to the body of the guitar enables the “neck and string assembly” to rest in a near vertical position when played while standing. Suspended by use of a strap, this instrument provides the musician better access to the neck with the fretting hand, easy access to the strings with the plucking hand, and is incredibly resistant to unwanted swaying or rocking caused by the natural acts of striking and fretting strings, and normal body movements.

### CROSS REFERENCES TO RELATED APPLICATION

“This application claims the benefit of Provisional Patent Application Ser. No. 60/257,782 filed Dec. 26, 2000

U.S. Pat. No. 6,040,509 Mar. 21, 2000 Fanella

U.S. Pat. No. 5,171,927 Dec. 15, 1992 Kubicki, Browne

### BACKGROUND

1. Field of Invention

This invention relates to electric guitars and bass guitars, specifically to the design flaws that exist in prior art that hinders the musician's ability to enjoy unrestricted movement when playing the instrument while standing using a guitar strap. Electric guitars today are most commonly built from a single flat piece of material, usually wood. Some electric guitars are simply acoustic guitars (guitars that require a soundboard to project sound) with pickups installed or are what the industry often calls a “semi-hollow” body guitar. A semi-hollow body guitar has a soundboard; however by it's construction, it is usually not as responsive. This invention focuses on solid body electric guitars that use no soundboard for amplification).

2. Description of Prior Art

Guitars were originally invented to be played from a sitting position. They could be nestled on the lap in such a way that they were very stabile (immobilized). As it became necessary to stand during performances, a guitarist would attach a strap to the instrument. The guitar was less stabile suspended from a strap but the freedom gained on stage was worth the trade off.

The first electric guitars were simply acoustic guitars with “pickups” installed. Some time later it was discovered that the pickups reproduced the sound of the strings very well and the need for an acoustic soundboard was no longer necessary. This meant that the guitar body could be carved from a flat piece of solid wood in nearly any shape a designer could imagine. With this new freedom, many new shapes began to appear on the market.

In October of 1951 the first solid body electric bass guitar was shipped from the Fender factory. From that day forward the bassist was able to roam the stage with as much ease as the guitarist. The 1951 Fender electric bass guitar has been touted as the bass that changed the sound of music forever, and indeed it has. Today, 50 .years later, the electric bass is still designed and manufactured by many companies with virtually no structural or design changes. The electronics has improved considerably, however, the rest of the instrument is basically unchanged.

The common electric bass guitar is simply a guitar with bass strings on it. It is symmetrical; meaning, the “neck and string assembly” is placed in a central location that straddles the centerline of the guitar body. Today's modern electric guitars are still shaped very similar to acoustic guitars, apparently for traditional reasons. Acoustic guitars are symmetrical because the bridge (also known as the saddle) of the guitar has to be located near the center of the soundboard to project the sound at an adequate level. It is not, however, necessary for a “solid body electric guitar” design to be restricted in this manner.

The body of the electric guitar is made from a single flat piece of material (usually wood). The material and composition may vary but the design of a single flat plane is common among all electric guitars. The shape along the edge of the flat piece of material has been the focus of most design alterations. These alterations have been mostly cosmetic in nature that provide little or no benefit to the musician other than aesthetic qualities. There is no practical reason, other than the ease of construction, electric guitars are made from a single flat plane.

Since electric guitars are flat and the human torso is curved, the flat plane of the guitar body has a tendency to rock or sway from subtle motions produced by the act of playing the instrument. The advantage of playing the guitar from a sitting position is, the musician can nestle the guitar in the lap in such a way as to prevent unwanted rocking or swaying of the guitar. The musician forfeits the luxury of instrument stability while standing when using a common single strap dual anchor system, known as a guitar strap, to suspend the instrument.

Bass guitars are notorious for being what the industry calls, “neck-heavy.” A bass guitar neck in a horizontal position, when played with a guitar strap while standing, is more susceptible to becoming “neck-heavy.” The term “neck-heavy” describes the phenomenon that occurs when gravity pulls on the guitar neck. When the neck of the guitar sags downward the musician is required to compensate in some way, either by exerting energy to support the neck (thereby causing restriction of movement) or pause briefly to readjust the instrument. This is especially noticeable in bass guitars because of the longer neck length, approximately nine inches longer than a standard six-string guitar. The longer neck coupled with larger, heavier tuners, present a noticeable downward pull on the guitar. Most bass guitar builders try to remedy this problem by elongating the top of the guitar body that the strap is attached to. This helps what is known in the industry as “the balance.” By moving the attachment point toward the neck, the weight of the body can help overcome the downward gravitational pull on the neck. One design innovation eliminated the heavy tuners by placing them on the bridge located on the body of the bass, thereby eliminating the headstock completely (U.S. Pat. No. 5,171,927_inventors Philip Kubicki; Ronald 0. Browne, Dec. 15, 1992)

Fig.7 demonstrates the typical, horizontal, neck position of prior art. From this position the musician is forced to either curl the wrist of the fretting hand or bring the thumb over the top of the neck so as to get the fingers close enough to reach the top strings. Classical guitarist's use a technique for holding their instrument that places the “neck and string assembly” in a more vertical position than is common for guitarist's that use a guitar strap while standing. This more vertical position helps the guitarist place the fretting hand underneath the neck, allowing the wrist to remain straight. Every accomplished guitarist's understands that a curled wrist will reduce dexterity. The vertical position is the position that double bass (a large acoustic bass that looks much like a very large cello) players use, as do those that play cello. Keith Fanella understood the importance of proper neck position. His U.S. Pat. No. 6,040,509 is a harness apparatus that allows the musician to position the guitar in a more vertical position while standing.

Keith Fanella also points out in the background section of his patent that, “while the instrument can be vertically adjusted by changing the strap length, the angle of the elongated neck along its periphery cannot be adequately adjusted.” His point is “prior art does not allow the angle of the neck to be placed in a more vertical position by use of a conventional single strap, dual anchor system.” His solution was to change the support mechanism. Fanella continues to point out that “it is not possible to adjust the angle of the fretboard surface along its axis in a rotational manner or obliquely” and “it is not possible to adjust the angle of the elongated neck obliquely, to a raised position along its periphery and/or rotationally, similar to the way a cellist positions their instrument and maintain that position without undue muscular effort.” His assertions are true concerning prior art. Prior art does not allow a “user-friendly” playing position when suspended by a single strap, dual anchor system (guitar strap).

This invention was conceived from a desire to create a bass guitar that could be played from a standing position, with the aid of a strap only that would place the neck in a similar position to that of a classical guitar when played from a sitting position (orthodox classical position). In doing so the inventor set out on a path that would ultimately lead him to discover many things about the electric bass guitar that have been overlooked by manufacturer's and bassist's alike. The inventor also discovered that this invention could be applied to standard solid body six string guitars as well with great success.

### SUMMARY INCLUDING OBJECTS AND ADVANTAGES

The above mentioned invention provides a unique guitar comprised of a body constructed in such a way as to allow the neck of the guitar to be placed on one plane of the body and the alternate plane, or planes, to conform to the curved shape of the human torso, thereby providing stability of the instrument.

This particular improvement upon prior art also allows the neck of the guitar to be placed “off-center” in relation to the body of the guitar so that the neck is able to rest in a more vertical position than that of prior art when played while standing using a common guitar strap. The result of these important structural changes creates an ergonomic benefit to the user (musician).

### Objects and Advantages

Accordingly, several objects and advantages of my invention are to:

1. Create a superior design to that of prior art that allows the musician to experience a more comfortable and therefore, more pleasurable playing experience.

2. Place the “neck and string assembly” in a more vertical playing position than that of prior art, similar to that of a cello or upright acoustic bass (also known as a “double bass”), when suspended by a common single strap, dual anchor system (guitar strap) while standing.

3. Stabilize the guitar when being played suspended by a single strap, dual anchor system. This is achieved by using the dual-plane guitar body design. See FIG. 8 (my invention) and FIG. 9 (prior art).

4. Allow the musician to keep wrists straight and arms relaxed while playing because of the improved ergonomic attributes that this invention has over prior art.

5. Provide a remedy for the “neck-heavy” problem that exists particularly with electric bass guitars. This is achieved by the off-center (asymmetrical) position of the neck reduces the effect that gravity has on the instrument. The more vertical position of the neck reduces the effect that gravity has on the instrument.

6. The more vertical position of this invention allows the musician to make use of an optional second but shorter guitar strap that eliminates all unwanted motion and is as easy to use as the shoulder strap. See FIG. 10.

Further objects and advantages of my invention will become apparent from a consideration of the drawings and ensuing description.

### BRIEF DESCRIPTION OF THE DRAWINGS

FIG. 1 is a perspective view of the anatomy of this invention.

FIG. 2 is a bottom view showing the dual-plane construction of the guitar body.

FIG. 3 is a bottom view showing a possible variation of this invention.

FIG. 4 is a sketch demonstrating why the vertical neck position is desirable.

FIG. 5 is a sketch demonstrating why the horizontal neck position is undesirable.

FIG. 6 is a perspective view of this invention played while standing with the aid of a guitar strap.

FIG. 7 is a perspective view of prior art played while standing with the aid of a guitar strap.

FIG. 8 is a sketch of this invention demonstrating why a dual-plane guitar body is more stabile than prior art.

FIG. 9 is a sketch of prior art demonstrating why a single-plane guitar body is less stabile than this invention.

FIG. 10 is a perspective front and rear view of this invention being played by a musician using the primary shoulder strap and a secondary optional waist strap.

### Reference Numerals

1—front strap button, for attaching shoulder strap

2—rear strap button, for attaching shoulder and waist strap

3—lower front strap button, for attaching waist strap

4—shoulder strap

5—waist strap

6—fretting hand

7—plucking hand

10—neck and string assembly comprising:

11—tuners

12—headstock

13—neck

14—fingerboard

15—strings

16—pickup

17—bridge

20—the lower plane of the dual-plane guitar body

21—line indicating the placement of lower plane

24—area of contact between this invention and the human torso

25—the single-plane guitar body of prior art

26—area of contact between prior art and the human torso

28—human torso

30—the upper plane of the dual-plane guitar body

31—line indicating the placement of upper plane

40—the electronics cavity

41—electronic control knobs

42—female cord jack

50—line indicating the vertical neck position

51—line indicating the horizontal neck position

52—straight wrist

53—bent or curled wrist

### PREFERRED EMBODIMENT

Description

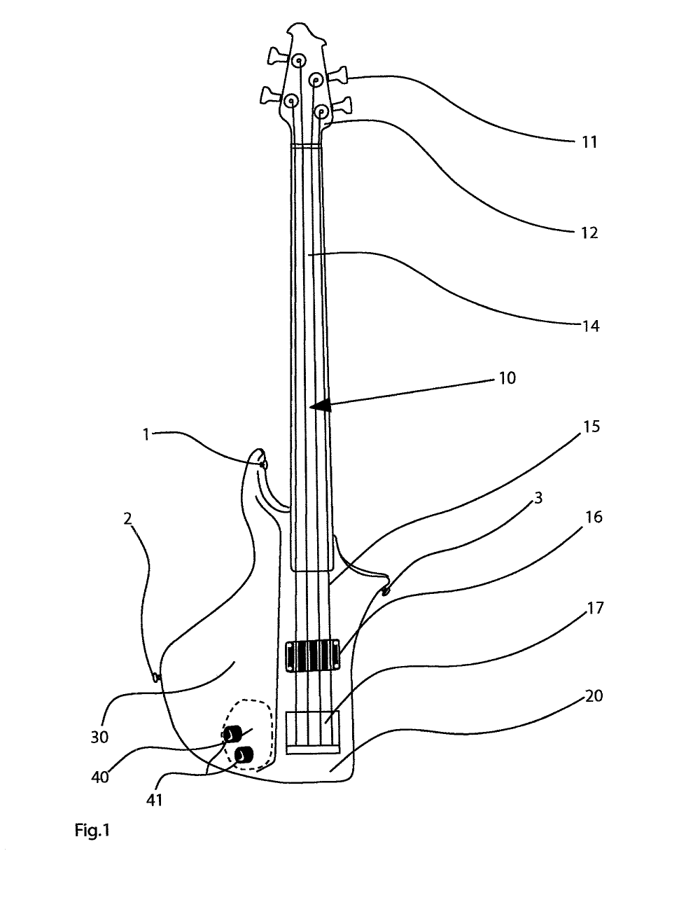

As shown in FIG. 1 the anatomy of the asymmetrical dual-plane bass guitar. The “neck and string assembly” 10 consists of; mechanical tuners 11, the headstock 12, the neck 14, the strings 15, at least one pickup 16, and a bridge 17 (also known as a tail-piece). The front strap button 1 is the apparatus that is attached to the guitar strap as one of the two anchors for a guitar strap. The rear strap button 2 is the other anchor for the same strap. There is a third, optional, strap button 3 located below the neck on the lower-plane 20. This strap button 3 is for the use of a second, but shorter, single strap dual anchor system 5 that will be connected to strap button 2 and strap button 3. This second, optional, strap 5 will go around the body of the musician at the waist to aid in holding the instrument close to the body. This secondary strap 5 is not necessary for the operation of this invention, however it does provide added stability to the invention.

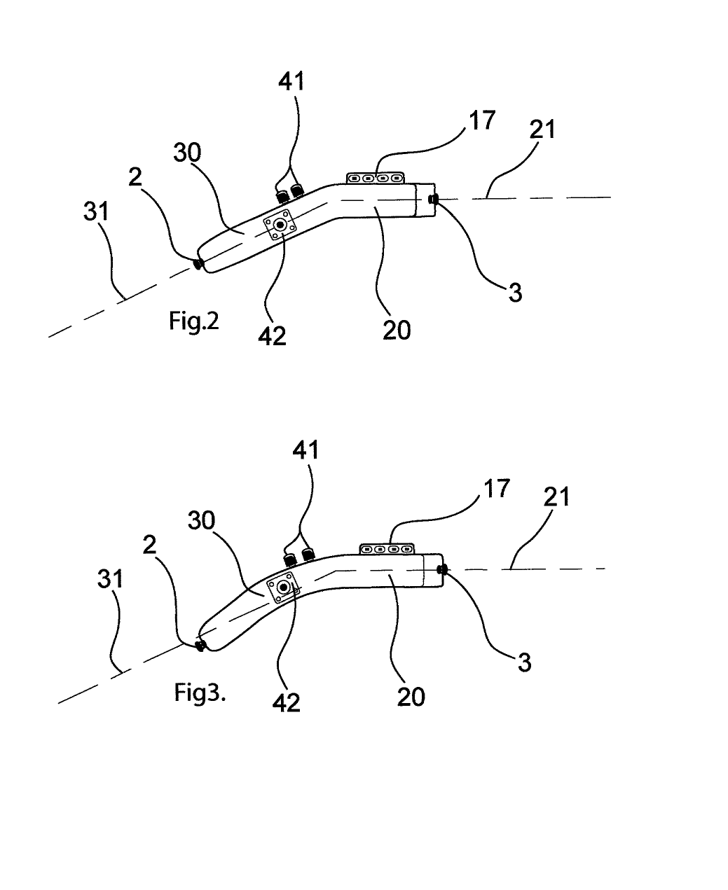

As shown in FIG. 2 provide a bottom view of this invention and the two planes 21 & 31, the upper plane 30 and the lower plane 20.

As shown in FIG. 3 provides a bottom view of this invention as a curved version. The curved shape of FIG. 3 is essentially the same invention as FIG. 2. The tangent of the arc becomes the upper plane 31.

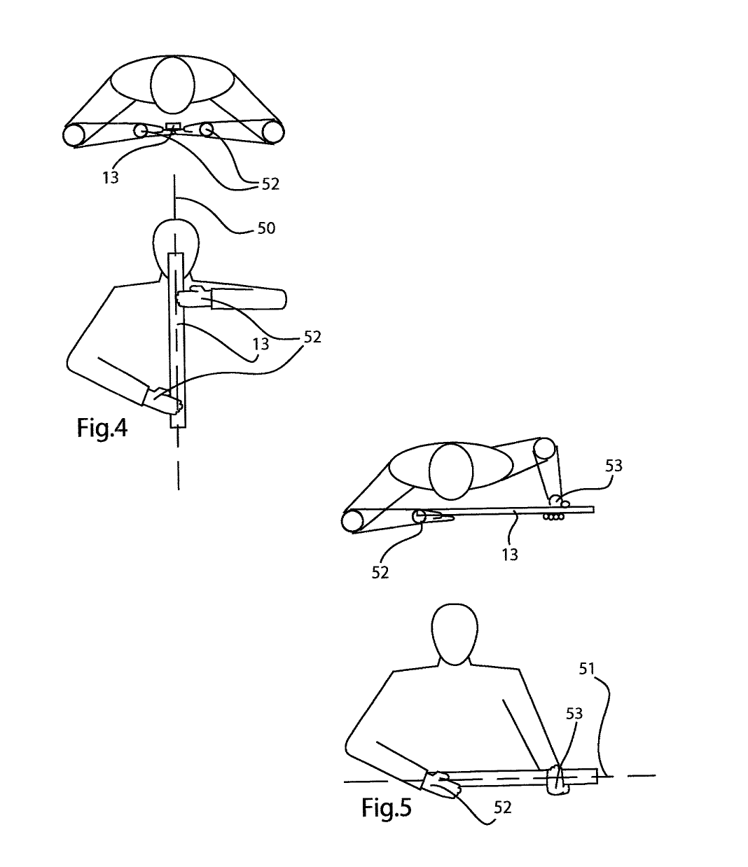

As shown in FIG. 4 a sketch of a vertical placement 50 of a neck 13 in relation to the human body. Because of the symmetrical nature of the human body the vertical position 50 is the optimum position that enables both wrists to be straight (in-line with the forearm).

As shown in FIG. 5 a sketch of a horizontal placement 51 of a neck 13 in relation to the human body. Because of the symmetrical nature of the human body the horizontal position 51 is an adverse position that does not allow both wrists to be straight.

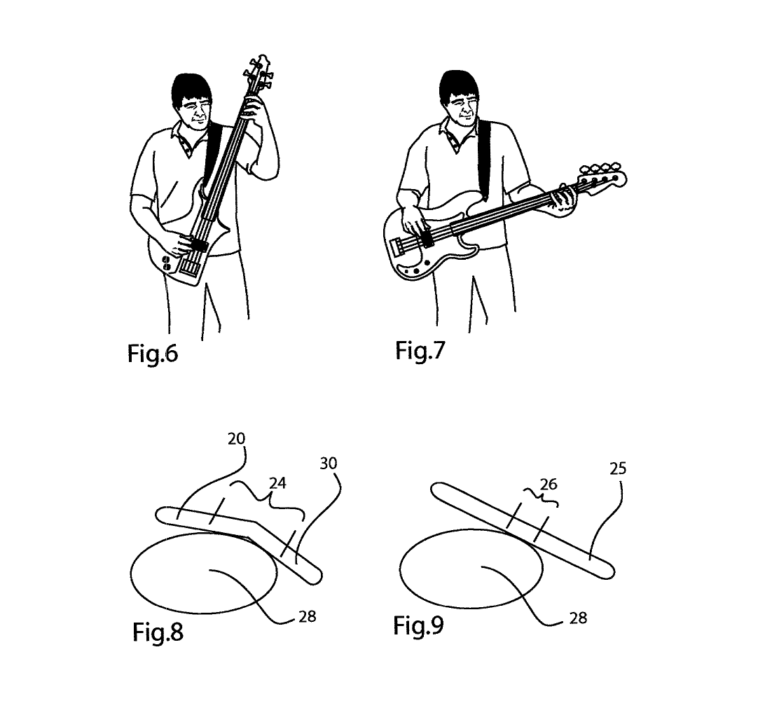

As shown in FIG. 6 a perspective view of this invention, noting the near vertical position of the neck.

As shown in FIG. 7 a perspective view of prior art, noting the near horizontal position of the neck.

As shown in FIG. 8 a sketch of this invention as a rough top sectional view as it would rest against the human torso 28. This sketch demonstrates why the bent or curved nature of this invention enables it to have greater stability than prior art. The upper plane 20 makes contact with a certain amount of area with the torso 28 and so does the lower plane 30. The two planes in tandem provide much more surface area contact 24 with the human torso 28 than that of prior art.

As shown in FIG. 8 a sketch of this invention as a rough top sectional view as it would rest against the human torso 28. This sketch demonstrates why the bent or curved nature of this invention enables it to have greater stability than prior art. The upper plane 20 makes contact with a certain amount of area with the torso 28 and so does the lower plane 30. The two planes in tandem provide much more surface area contact 24 with the human torso 28 than that of prior art.

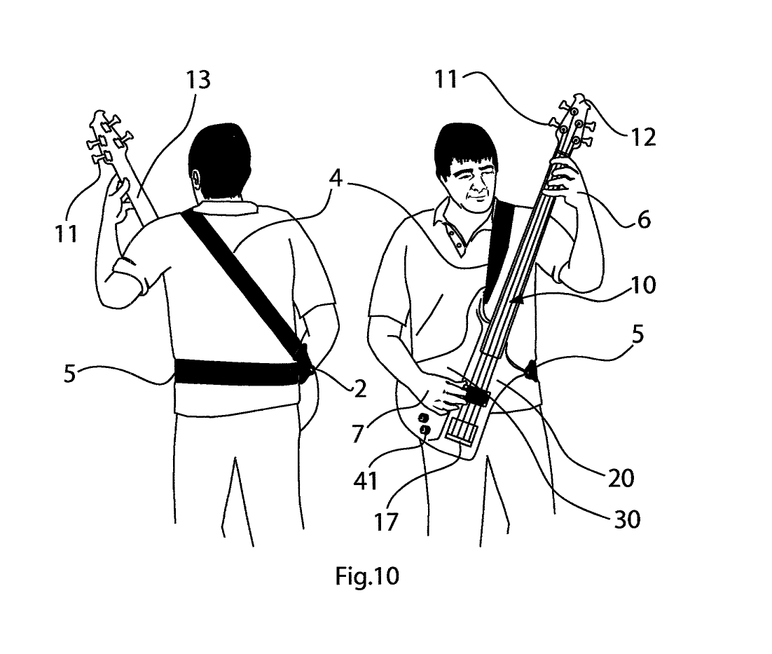

As shown in FIG. 9 a sketch of prior art as a rough top sectional view as it would rest against the human torso 28. This sketch demonstrates why the flat nature of prior art prevents it from providing stability. The flat plane of prior art 25 make very little surface contact 26 with the human torso 28 and actually encourages the human torso 28 to roll against the flat surface of the guitar body.

As shown in FIG. 10 a perspective front and rear view of the musician playing this invention using a conventional strap 4 over the shoulder and a second, optional, strap 5 worn around the waist. The second strap 5 is used to keep the guitar snug against the body. The shoulder strap 4 is anchored at strap buttons 1 & 2 and the waist strap 5 is anchored at strap button 3 and shares strap button 2 with the shoulder strap 4.

### PREFERRED EMBODIMENT

Operation

The goal of this invention is to create an instrument that places the “neck and string assembly” 10 in a position that best suits the needs of the musician without changing the mechanics of the instrument and to be more stabile than that of prior art when played while standing using a common guitar strap. This invention is designed to aid the musician in achieving a more natural and relaxed playing experience.

The instrument is supported by a single strap, dual anchor system (guitar strap) 4; as is the case with prior art. The length of the strap 4 determines what angle the neck shall rest; the shorter the strap 4 the less vertical it will rest, the longer the strap 4 the more vertical it will rest. The use of a secondary guitar strap 5 can be used to help completely immobilize the instrument from unwanted swaying when played. This secondary strap 5 is worn around the waist as shown in FIG. 10. Although this instrument is very comfortable without the use of this strap, the musician will enjoy the stability that it provides. Stability of the instrument translates into real freedom of motion for the musician.

The proto-type of this invention was made by shaping a single, flat piece of wood. The single piece was ripped in two along the center. The two pieces were then beveled at a 12½-degree angle along the fresh cut. The two pieces were then glued together again so that the two 12½-degree angles combined created a 25-degree angle. This invention is not restricted to this angle; the angle can be adjusted so that it can be custom fit to a particular musician.

The dual-plane structure of the guitar body conforms to the curved nature of the human torso 28 as shown in FIG. 8. FIG. 9 demonstrates how that prior art 25 fails to conform to the curved nature of the human torso 28; therefore prior art 25 has a tendency to roll across the torso 28 when force is exerted on it from the natural act of moving the hand around the fingerboard and pressing strings against the neck. FIG. 8 demonstrates that the dual-plane structure of the guitar body creates two areas of contact between the guitar body and the human torso. This expended area of contact 24 helps reduce the rolling motion across the torso when pressure is applied and released on the neck of the guitar.

The use of the secondary strap 5 around the waist as shown in FIG. 10 pulls the instrument in tight against the torso. This invention is fairly stabile without the use of this secondary strap; however, the secondary strap eliminates almost all unwanted movement of the instrument when played. The secondary strap is optional with this invention.

### Conclusions, Ramifications, and Scope

Accordingly, it can be seen that this invention has improved upon prior art in that it enables the musician to enjoy a playing experience that has not been available to them until now. This is achieved because the asymmetrical design of this invention places the “neck and string assembly” in a position that allows the musician to keep both wrists straight, therefore, enabling unrestricted dexterity. Because this invention conforms to the shape of the human torso better than prior art it becomes more stabile and moves very little when played. By adding a secondary strap around the waist this instrument becomes so stabile that swaying is reduced to negligible level.

Although the description above contains many specificities, these should not be construed as limiting the scope of the invention but as merely providing illustrations of some of the presently preferred embodiments of this invention. Various other embodiments and ramifications are possible within it's scope. For example, the two planes could also be joined by a hinge that can be locked into place so as to be adjustable, if for no other reason than to have and instrument to help custom fit a fixed asymmetrical dual-plane guitar body. This invention is also not restricted to being comprised of only two planes. The scope of this invention clearly intends to provide a means to custom fit musicians with an instrument that is both comfortable and easy to play.

Thus the scope of the invention should be determined by the appended claims and their legal equivalents, rather than by the examples given.

What is claimed is:

1. an improvement of a string instrument, commonly known as a guitar comprising:
a) a body comprising a single flat piece of material suitable for the construction of a guitar body joined by some means to another flat or curved piece of material suitable for the construction of a guitar body so that each piece of said material exists on an independent plane whereas the two or more planes share a common edge at the joint consecutively, and
b) a neck, attached by some means to, or inclusive of, one of said planes of said body, and
c) said neck provides a means to anchor a plurality of strings at the end of said neck, and
d) said body provides a means to anchor the opposite end of said plurality of strings onto said body, and
e) a pickup or plurality of pickups that provide the means to electronically amplify the sound created by the vibration of said strings, and
f) no less than, but not limited to, two attachment apparatus used to attach one or more straps to said string instrument for the purpose of suspending said string instrument while standing
whereas the shape of said string instrument enables the musician to play said string instrument so that the position of said neck is more vertical than that of prior art, and
whereas the shape of said string instrument creates a greater area of contact between the back of said body of said string instrument and the human torso than that of prior art when said string instrument is suspended by the use of one or more straps.
